(19) United States
(12) Patent Application Publication
(10) Pub. No.: US 2006/0031872 A1
(43) Pub. Date: Feb. 9, 2006

(54) System and method for real-time displaying of blocked and locked out status of programs in electronic program guides

(76) Inventors: Eric Hsiao, Carlsbad, CA (US); Kim Annon Ryal, Mason, MI (US)

Correspondence Address: WAGNER, MURABITO & HAO LLP, Third Floor, Two North Market Street, San Jose, CA, 95113, US

(21) Appl. No.: 10/911,465

(22) Filed: Aug. 3, 2004

(51) Int. Cl. H04N 7/16; H04N 5/445; G06F 13/00

(52) U.S. Cl. 725/28; 725/25; 725/27; 725/39; 725/6

(57) ABSTRACT

A method for displaying electronic programming guide (EPG) information is disclosed. The method includes determining whether content to be delivered over a media stream is blocked, and, if so, indicating the blocked status on a grid of the electronic programming guide corresponding to the blocked content. The blocked status may result from a locked-out channel or it may result from a program exceeding a preset maximum allowable rating.

### RELATED ART

Set-top boxes (STBs), some of which enable a television set to become a user interface to the Internet, and others which also enable a television set to receive and decode digital television broadcasts, are becoming increasingly popular. Digital television STBs may be used for satellite, cable, and terrestrial digital television services.

Currently, STBs, either for Cable, Satellite or terrestrial TV, with Electronic Programming Guide (EPG) capabilities, show program information in the familiar “TV Guide” grid format. That is, they display, in a scrollable format, what programs are currently showing or will be showing in the near future. Also, some television sets have built-in EPGs. These television sets may receive the guide data over video blanking interval (VBI) broadcasts which is the same method used for delivering closed captioning and V-chip rating information.

Users generally have the capability of locking out channels and/or setting rating limits for programs that may be viewed, whether through an STB or through the V-chip settings in the television set. In other words, a parent may wish to prevent a child from watching certain channels, or programs that have ratings above a certain level.

At the present time, EPG program grid displays have no regard for locks and limit settings that a user may have employed. Therefore, a user has no notification at the EPG grid level that a program or channel is blocked. Conventionally, once the user selects a program from the EPG, the EPG will then determine if it is blocked and, if so, it will display the locks and limits screen, necessitating the user to enter a PIN or passcode to bypass the block. This may be unduly time-consuming and inconvenient to a user because it allows EPG selection for channels and programs which the user may not have permission to view.

### SUMMARY OF THE INVENTION

Embodiments of the present invention are drawn toward a method and system for real-time displaying of locks and limit settings for electronic program guides. An entire channel may be blocked by a user, or individual programs may be blocked if they have a rating that exceeds a user selected rating limit. As a result, it is possible to discern at the electronic program guide which channels and/or programs are blocked to avoid the inconvenience associated with selecting a program only to later find that it is blocked.

A method is disclosed for displaying electronic programming guide (EPG) information. As discussed below, the method includes determining whether content to be delivered over a media stream is blocked, and, if so, indicating the blocked status on a grid of the electronic programming guide corresponding to the blocked content. The blocked status may result from a locked-out channel or it may result from a program exceeding a preset maximum allowable rating. As described below, various display attributes can be used to illustrate the blocked status of a program or channel. A program and/or channel may also have a blocked status because it is not subscribed to by the user.

According to one embodiment, the indication of a program or channel having a blocked status may include displaying a listing of the scheduled media broadcast having a blocked status in a bar that is dimmed in intensity compared to the intensity of listings of non-blocked scheduled media broadcasts of the electronic program guide. In another embodiment, the indication may consist of displaying a listing of the scheduled media broadcast having a blocked status in a font color that is the same as its background color, thereby rendering the listing transparent, e.g., non-viewable.

In other embodiments, the indication may consist of displaying a listing of the scheduled media broadcast having a blocked status with a background color that is significantly different from the background color(s) used for displaying listings of non-blocked scheduled media broadcasts of the electronic program guide. Alternatively, it may consist of displaying the listing of the scheduled media broadcast having a blocked status with a font color that is significantly different from the font color(s) used for displaying listings of non-blocked scheduled media broadcasts. In one embodiment, the indication may also include the generation of an audible sound when a cursor is moved over the display of a listing of a scheduled media broadcast that has a blocked status.

In other embodiments, the blocked status due to ratings limitations and the blocked status due to non-subscribed programs/channels may be visually distinct. The viewer may be given an option to visually differentiate blocked program guide information or to altogether prevent display thereof.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a media broadcast receiving system utilizing a media broadcast programming interface system in accordance with an embodiment of the present invention.

FIG. 2 is a block diagram illustrating one embodiment of a consumer electronic network utilizing a media broadcast programming interface system in accordance with the present invention.

FIG. 3 is a block diagram illustrating another embodiment of a consumer electronic network utilizing a media broadcast programming interface system in accordance with the present invention.

FIG. 4 is a flowchart of a method, in accordance with one embodiment of the present invention, for displaying a blocked status of a scheduled media broadcast, in real-time, on a grid of an electronic programming guide supplied to a display device.

FIG. 5A is a block diagram illustrating embodiments of an electronic programming guide as displayed on a screen of a display device in accordance with the present invention.

FIG. 5B is a block diagram illustrating one embodiment of an electronic programming guide as displayed on a screen of a display device in accordance with the present invention.

FIG. 5C is a block diagram illustrating another embodiment of an electronic programming guide as displayed on a screen of a display device in accordance with the present invention.

FIG. 5D is a block diagram illustrating yet another embodiment of an electronic programming guide as displayed on a screen of a display device in accordance with the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “receiving” or “recognizing” or “utilizing” or “determining” or “playing” or “outputting” or “transmitting” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

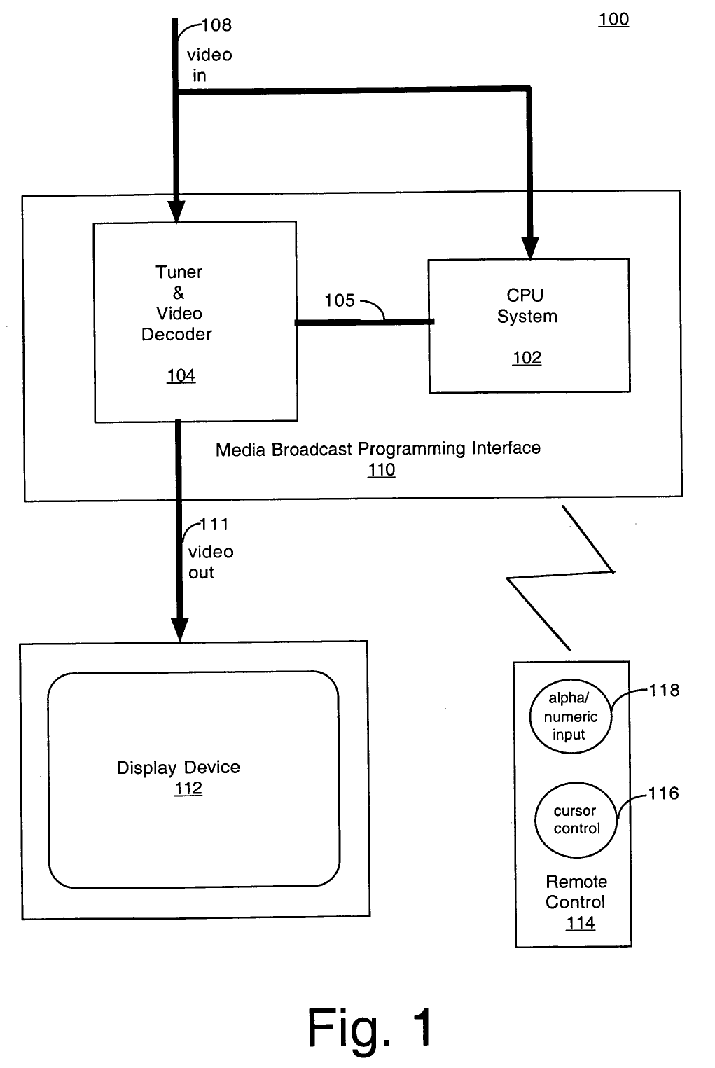

FIG. 1 is a block diagram of a media broadcast receiving system 100 utilizing a media broadcast programming interface 110 in accordance with an embodiment of the present invention. Within the following discussions of the present invention, certain processes and steps are discussed that are realized, in one embodiment, as a series of instructions (e.g., software program) that reside within computer readable memory units of media broadcast programming interface 110 and executed by processor system 102 of interface 110. When executed, the instructions cause media broadcast programming interface 110 to perform specific actions and exhibit specific behavior which is described in detail below. System 102 includes a processor coupled to a bus and memory units, e.g., RAM and ROM, coupled to the bus.

In general, media broadcast receiving system 100 of FIG. 1, as used by an embodiment of the present invention, comprises a media broadcast programming interface system 110 for providing a user a selectable interface with media broadcasts. Media broadcast programming interface 110 comprises an communication bus 105 for communicating information, a processor system 102 coupled with bus 105 for processing information and instructions. Processor system 102 may include a microprocessor or any other type of processor. The media broadcast programming interface 110 also includes a tuner and video decoder 104, controlled by CPU system 102 having circuitry for tuning and decoding video input signal 108 and generating video output signal 111.

In various embodiments, media broadcast programming interface 110 may be a set-top box for digital cable interface, for satellite interface, for terrestrial broadcast interface, or any type of media broadcast programming interface that provides an interface with which a user may select or program various functions for controlling viewing of media broadcasts.

Media broadcast receiving system 100 includes a display device 112, such as a television set or a computer monitor, which receives video output signal 111 for displaying video and/or graphics. It should be appreciated that display device 112 may be a cathode ray tube (CRT), flat panel liquid crystal display (LED), field emission display (FED), plasma display or other display device suitable for displaying video and/or graphic images. Furthermore, the media broadcast receiving system 100 can optionally include a control device 114 including alphanumeric and function keys 118 and a cursor control or cursor directing device 116 for communicating user input information and command selections to media broadcast interface 110. The control device 114 can be implemented using a number of well known methods such as a remote control device (e.g., a universal remote control device having a number of buttons, dials, etc.) with an infra-red signal communication capability or it may be a wired input panel on the media broadcast interface system and coupled to the video decoder 104 circuitry. The present invention is also well suited to directing a cursor by other means such as, for example, voice commands. In addition, the cursor control 116 can also be a mouse, a track ball, a track pad, an optical tracking device, a touch screen, etc. Alternatively, it is appreciated that a cursor can be directed and/or activated via input from alphanumeric input device 118 using special keys and key sequence commands.

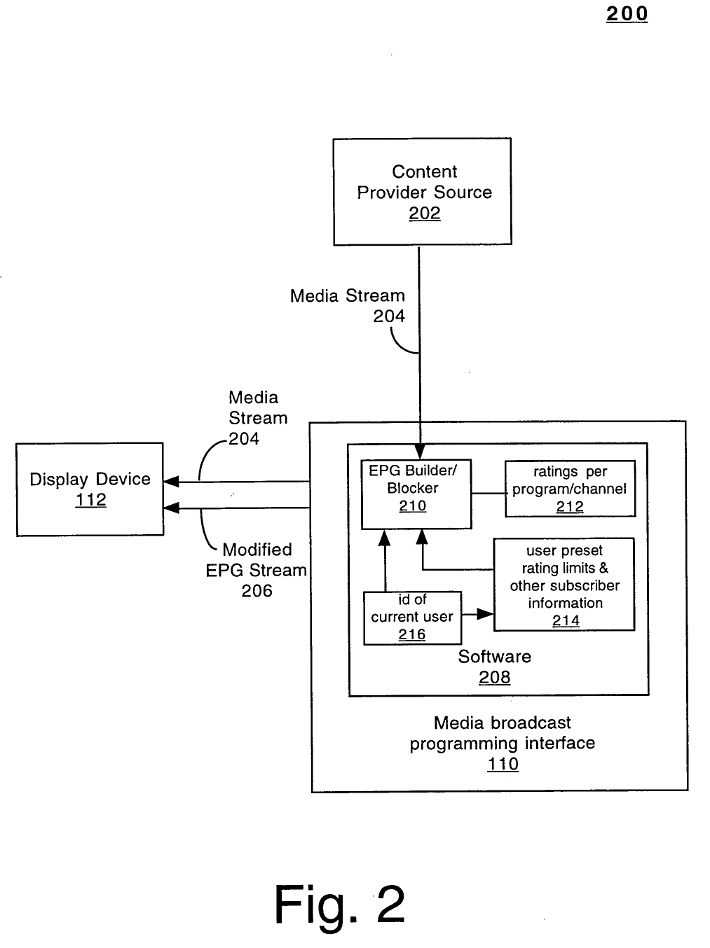

With reference now to FIG. 2, which is a block diagram illustrating one embodiment of a consumer electronic network 200 utilizing a media broadcast programming interface 110 in accordance with the present invention. According to the present embodiment, media broadcast programming interface 110 may,be a set-top box. Media broadcast programming interface 110 may be a digital cable set-top box, a satellite set-top box, a terrestrial set-top box or any type of device that provides a programming interface between a broadcast media stream 204 and a display device 112. In one embodiment of the present invention, when a user of media broadcast programming interface 110 sets locks and limits for channels and/or programs to be blocked, software 208 reads electronic programming guide (EPG) information from media stream 204 in real-time, determines the ratings of programs and compares them to limit settings and checks for blocked channels and unsubscribed content.

Software 208 comprises an EPG builder/blocker 210 that has access to the ratings of programs, as shown in block 212 of software 208, that are broadcast along with the EPG information over media stream 204. At block 214 of software 208, a user may set and/or reset limits and/or block channels via an input control device (e.g., remote control device 114 of FIG. 1) after identifying himself by a user id, as indicated in block 216. EPG builder/blocker 210 then compares the ratings of the programs (block 212) to be listed in the EPG to the user's limit settings (214) and checks for blocked channels and unsubscribed content. If a program rating equals or exceeds a preset rating limit, or if a channel is blocked or content is not subscribed to, EPG builder/blocker 210 modifies the EPG information to indicate the blocked status of any blocked channels and/or programs. Media broadcast programming interface 110 sends the modified EPG information over media stream 206 to display device 112, along with media stream 204. Display device 112 then receives the modified EPG stream 206 and displays a grid containing the modified EPG information with an indication of any channels and/or programs that may be blocked.

Network 200 includes a content provider source 202 (e.g., television broadcast company, the Internet, television cable company, and the like) coupled to media broadcast programming interface 110, which is coupled to display device 112. As such, the media broadcast programming interface 110 is coupled to receive a media stream 204 which is output by content provider source 202. Furthermore, display device 112 is coupled to receive media stream 204 and EPG Stream 206, which has been modified to provide indication of blocked broadcasts, both of which are output by media broadcast programming interface 110.

It is appreciated that content provider source 202 and media broadcast programming interface 110 of the present embodiment are well suited to be coupled in a wide variety of implementations. For example, content provider source 202 and media broadcast programming interface 110 may be coupled via coaxial cable, copper wire, the Internet, fiber optics, wireless communication, and the like. Moreover, the media broadcast programming interface 110 and display device 112 of the present embodiment are also well suited to be coupled in a wide variety of implementations. For instance, media broadcast programming interface 110 and display device 112 may be coupled via fiber optics, wireless communication, coaxial cable, the Internet, copper wire, and the like.

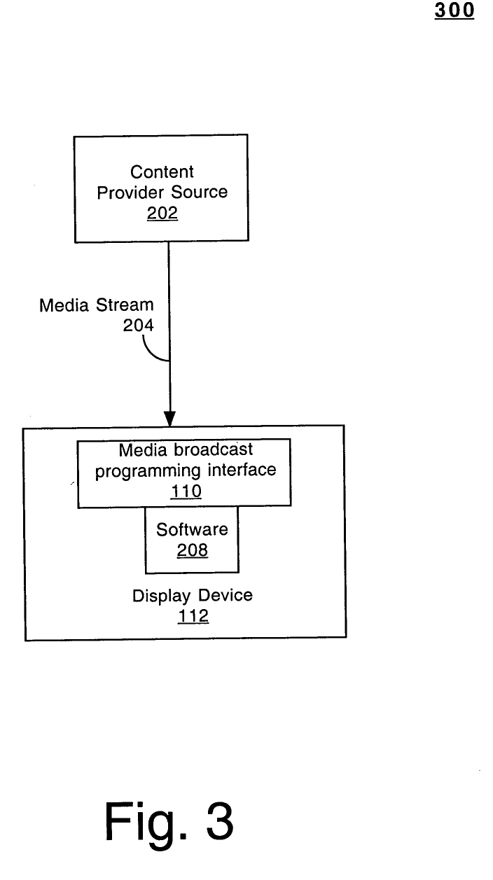

FIG. 3 is a block diagram illustrating another embodiment of a consumer electronic network 300 utilizing a media broadcast programming interface 110 in accordance with the present invention. According to the present embodiment, media broadcast programming interface 110 may reside within display device 112 and provide a programming interface between broadcast media stream 204 and the video display. In one embodiment of the present invention is that when a user sets locks and limits for channels and/or programs to be blocked (e.g., via a V-chip interface menu), software 208 reads electronic programming guide (EPG) information from media stream 204 in real-time, determines the ratings of programs and compares them to limit settings and checks for blocked channels at time of rendering. According to one embodiment, media stream 204 may receive EPG data through the use of the video blanking interval (VBI). Traditionally, VBI is used to carry closed captioning and extended data services (XDS) over Line 21. However, recently additional VBI lines are being used to carry EPG data, which include currently shown program data as well as future program guide data.

Once blocked information is identified, software 208 then modifies the EPG information to indicate the blocked status of any blocked channels and/or programs and renders it to the video display of display device 112. Display device 112 then shows a grid containing the modified EPG information with an indication of any channels and/or programs that may be blocked.

Network 300 includes a content provider source 202 (e.g., VBI broadcasts, network television broadcast company, the Internet, television cable company, and the like) coupled to media broadcast programming interface 110, which is coupled to and resides, along with software 208, within and as an integral part of display device 112. As such, the media broadcast programming interface 110 is coupled to receive media stream 204 that is output by content provider source 202. Furthermore, display device 112 is configured to display data from media stream 204 that has been modified by software 208 to provide indication of blocked broadcasts. It is appreciated that content provider source 202 and media broadcast programming interface 110, contained within and coupled to display device 112 of the present embodiment, are well suited to be coupled in a wide variety of implementations. For example, content provider source 202 and media broadcast programming interface 110 may be coupled via coaxial cable, copper wire, the Internet, fiber optics, wireless communication, and the like.

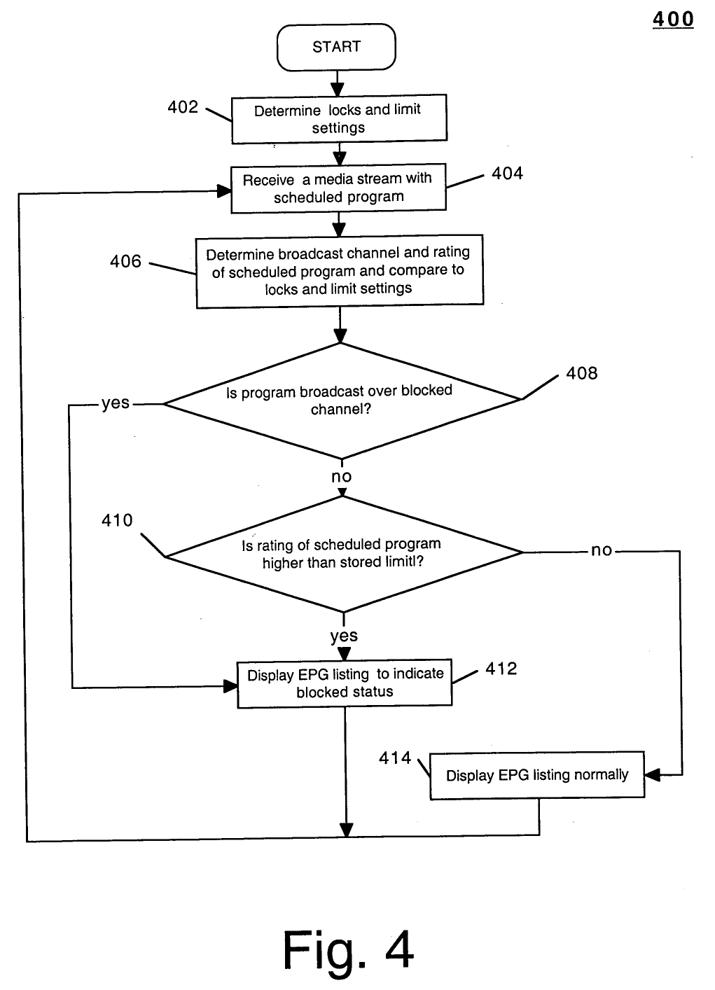

FIG. 4 is a flowchart of a method 400, in accordance with one embodiment of the present invention, for displaying a blocked status of a scheduled media broadcast, in real-time, on a grid of an electronic programming guide supplied to a display device. Although specific steps are disclosed herein describing the operations of method 400, such steps are exemplary. That is, embodiments of the present invention are well suited to performing various other steps or variations of the steps recited in the flowchart herein.

At step 402 of FIG. 4, media broadcast programming interface 110 determines locks and limit settings. These locks and limit settings may be set by a consumer to block the broadcasting of undesirable programs and/or channels. This information may be user-specific with each authorized user having different permission settings, e.g., maximum allowable ratings information. According to one embodiment, when the consumer electronic network contains a separate set-top box housing media broadcast programming interface 110 (e.g., network 200 of FIG. 2), the user may set the locks and limit settings at the set-top box. In another embodiment, the locks and limit settings may be set in a V-chip residing in display device 112. In the embodiment in which the consumer electronic network houses media broadcast programming interface 100 within display device 112 (e.g., network 300 of FIG. 3), the locks and limit settings reside in display device 112. Information regarding program subscription may also be determined at step 402.

At step 404 of FIG. 4, media stream 204 is received by a media broadcast programming interface (e.g., media broadcast programming interface 110 of FIG. 1). Media stream 204, according to the present embodiment, may contain program guide information for programs currently being broadcast and programs scheduled to be broadcast in the near future (e.g., the next 90 minutes). Media stream 204 attaches a program rating for each program listed in the program guide data broadcast.

At step 406 of method 400, the media broadcast programming interface 110 determines the rating and the broadcast channel for each of the scheduled programs. This information is typically contained in the program guide data broadcast over media stream 204. Media broadcast programming interface then compares the program broadcast channel and rating to the locks and limit settings.

At step 408, if the program is determined to be broadcast over a locked-out or unsubscribed channel, either by consumer selection or because it is not subscribed to by the consumer, method 400 proceeds to step 412 following step 408 and the electronic programming guide (EPG) displays the channel with an indication of its locked-out status. If the channel is not locked out, method 400 proceeds to step 410.

At step 410, if the rating of a schedule program is determined to be beyond the ratings limits set by the current consumer, or is not subscribed to by the consumer, method 400 proceeds to step 412 and displays the listing of the program, indicating its blocked status. If the program rating is not beyond the consumer's set limit and is subscribed to, method 400 proceeds to step 414 and displays the program listing in the normal manner.

At step 412, the locked-out channel or blocked program are listed in the EPG to indicate their blocked status. The indications may be the same for a locked-out channel and for an individual blocked program, or the indications may differ. These indications may, according to one embodiment, be by displaying, in the associated grid of the EPG, the programs broadcast over a locked-out channel and/or a blocked program in an intensity that is lower (dimmed) than that of non locked-out channels or blocked programs. In another embodiment, the background and the font may be displayed in the same color, causing the listing to appear blank. The locked-out channel and/or a blocked program status indication may, according to another embodiment, consist of displaying the background of the listing in a color that is distinctly different from that of the non locked-out channels and/or non-blocked programs.

According to another embodiment, the font color of a locked-out channel and/or a blocked program may be different from that of non locked-out channels and/or non-blocked programs. In yet another embodiment, the font for a locked-out channel and/or a blocked program may be a different style (e.g., italics) from that of non locked-out channels and/or non-blocked programs. In other embodiments, there could be any combination of the foregoing embodiments. It should be understood that the indication of a locked-out channel and/or a blocked program may be by any means that displays it differently from non locked-out channels and/or non-blocked programs.

At step 414 of method 400, if it is determined that a channel and a program do not have a blocked status, the associated grid of the EPG is displayed in the normal mode, and method 400 continues.

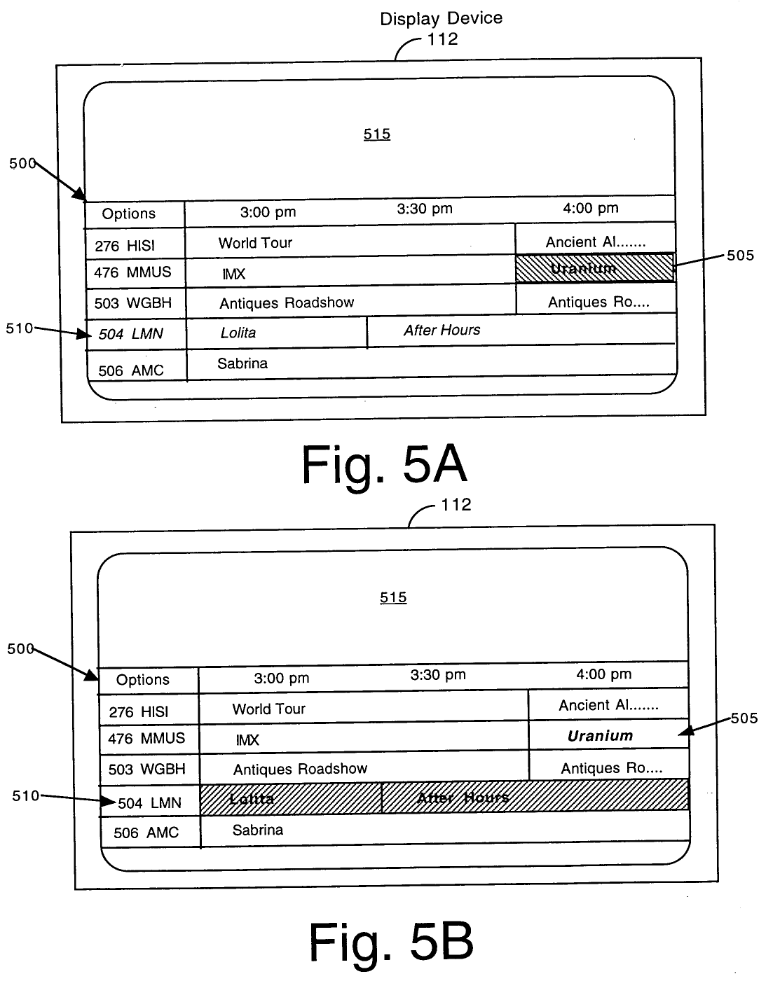

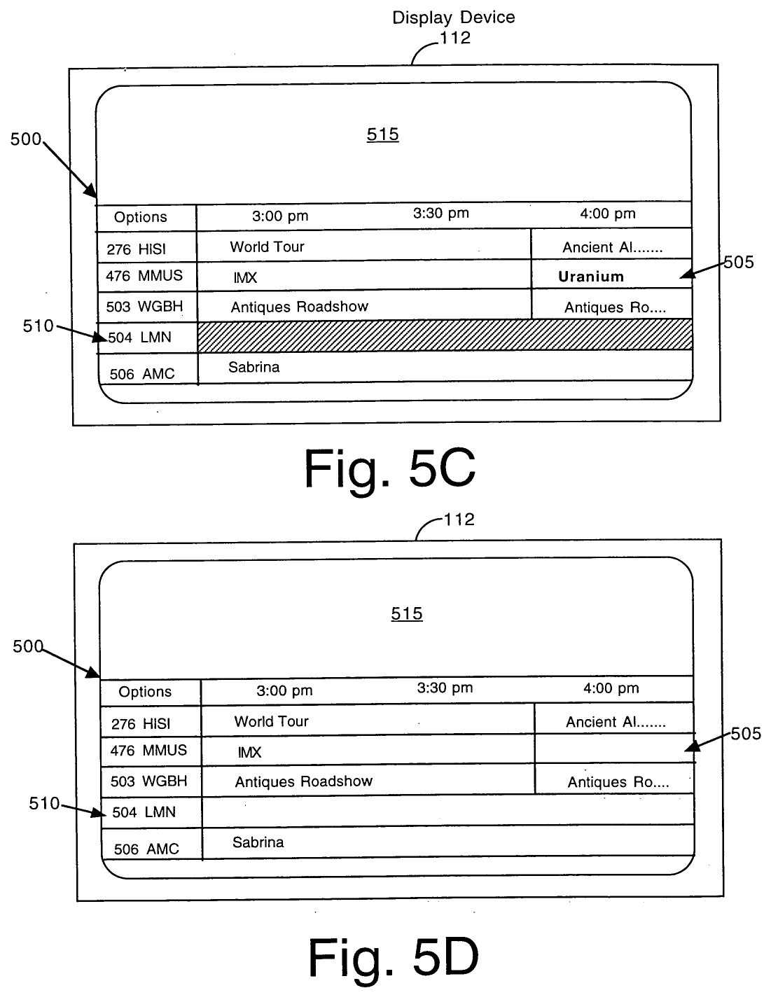

FIG. 5A-5D are block diagrams illustrating various embodiments of an electronic programming guide (EPG) grid 500 as displayed on the screen of display device 112 in accordance the present invention. Options such as television channel numbers and call letters of the channels are shown in the column of grid segments under “Options.” Programs that are or will be broadcast on the listed channels are listed in the same row or bar as their respective channel and in the columns below their scheduled run times, which are shown in 30 minute increments. For instance, channel listing 510 is for a channel number “504” having the call letters of “LMN.” The program “Lolita” is scheduled to run from 3:00 pm through 4:30 pm. Program listing 505 is for the program “Uranium” that is scheduled to run on channel 476, call letters MMUS, from 4:00 pm until 4:30 pm. Section 515 of EPG display 500 is an area that can display additional information about a future program when a user moves a cursor to the particular grid associated with the program of interest. A bar includes a foreground text portion and a background color portion.

According to one embodiment of the present invention, when a user has selected locks and limit settings in order to block the selection of undesirable channels and/or programs, or channels and programs to which the consumer does not subscribe, the blocked status can be indicated on the EPG display 500.

Referring to FIG. 5A, according to one embodiment of the present invention, if program content 505, “Uranium,” is determined to have a rating that exceeds the maximum allowable rating limits set by the user, program listing 505 may indicate its blocked status by being shown with a background color that is distinctly different from the background colors of the non-blocked program listings, e.g., red.

In another embodiment, the background and/or the font for listing 505 may be dimmed in intensity compared to the intensity of non-blocked programs. In yet another embodiment, the background and/or the font for listing 505 may blink to indicate the blocked status. In yet another embodiment, the style of the font for listing 505 may be different from that of the non-locked-out content, e.g., italics. However, it is understood that program listing 505 of the present embodiment is well suited to include a wide variety of different formats for indicating the blocked status of a program. For example, an audible sound may be produced when a user moves a cursor to a blocked program, thus indicating its blocked status.

In one embodiment of the present invention, an entire channel may be locked out due to objectionable content of its broadcasts. For example, channel 504 having call letters LMN may be locked out. In such an instance, the listing for the channel, including channel numbers and call letters, may be displayed to indicate its locked out status as described above for a blocked program. In one embodiment the locked out status of channel listing 510 may be the same as the blocked status indication of program listing 505. In other embodiments, the locked out status of channel listing 510 may be indicated by one or more of any alternative indications described above, for example, the listings may be in a different style, e.g., italics as is shown in FIG. 5A. In another embodiment, the channel number and call letters may be displayed normally and only the background and/or font are indicated in the described manner(s).

FIG. 5B is a block diagram illustrating an embodiment of the present invention in which the listing 505 for blocked program “Uranium” is displayed in italics. According to one embodiment, the listing may have a font color that is the same as that of the non-blocked programs, with the italics being the distinguishing feature. In another embodiment, listing 505 may be in both italics and in a color that is different than that of the listings for non-blocked programs, e.g., magenta. Also, channel listing 510 for blocked channel LMN 504 is illustrated as having a background that is different from that of the non-blocked channels. According to one embodiment, the background of the listing for blocked channel 510 may be displayed in a different color, e.g., orange or red, from that of non-blocked channels. In another embodiment, the background and/or the foreground of blocked channel listing 510 may be dimmed in intensity compared to that of non-blocked channels.

FIG. 5C is a block diagram illustrating another embodiment of the present invention in which listing 505 for blocked program “Uranium” is shown in a bold font to distinguish its blocked status from that of the non-blocked programs. It is understood that, in addition to the font for listing 505 being bold, it may also be a different font than that of the non-blocked programs, and it may also be of a different color than that of the non-blocked programs. Listing 510 for blocked channel LMN 504 is shown in the present embodiment to have a font that is the same color as that of the background, thereby rendering the listing 510 unreadable. In one embodiment the color of the font and background of listing 510 for the blocked channel are distinguishable from the backgrounds of the non-blocked content listings. In another embodiment, the “bar” containing the non-readable listing 510 may be caused to blink in order to distinguish it as being blocked.

FIG. 5D is a block diagram illustrating yet another embodiment of an electronic programming guide 500 as displayed on a screen of display device 112 in accordance with the present invention. Here, the background and the font of program listing 505 and of channel listings 510 are the same color and intensity, thereby rendering the grid blank or transparent in their respective listing locations. In other embodiments, program listing 505 may be displayed in an alternative manner (e.g., a distinguishing background color that is different from the font color) while the channel listing is blanked out, or vice versa. In one embodiment, the channel number and call letters may be shown while the channel's program listing(s) are blanked out. In another embodiment, the channel number and call letters may be blanked out along with the program listing(s), thereby leaving a blank row within the grid.

It is understood that there are many ways with which to distinguish a program and/or channel that has been blocked or locked-out from that of available programs and/or channels. Embodiments of the present invention are considered to encompass any and all such ways.

The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for displaying electronic program guide (EPG) information, said method comprising:
determining whether content to be delivered over a media stream is blocked; and
in response to said determining, indicating a visual blocked status on a grid of said electronic programming guide corresponding to blocked content.

2. The method as recited in claim 1 wherein said blocked status results from a locked-out channel.

3. The method as recited in claim 1 wherein said blocked status results from rating of a program exceeding a preset maximum allowable rating.

4. The method as recited in claim 1 wherein said grid comprises a listing of scheduled media content wherein a blocked status is indicated by a bar that is dimmed in intensity compared to an intensity of listings of non-blocked scheduled media broadcasts.

5. The method as recited in claim 1 wherein said grid comprises a listing of said scheduled media content wherein a blocked status is indicated by a font color that is the same as its background color, to render transparent a corresponding listing.

6. The method as recited in claim 1 wherein said grid comprises a listing of scheduled media content wherein a blocked status is indicated by a background color that is significantly different from the background color used for displaying listings of non-blocked scheduled media content.

7. The method as recited in claim 1 wherein said grid comprises a listing of scheduled media content wherein a blocked status is indicated by a font color that is significantly different from a font color used for displaying listings of non-blocked scheduled media content.

8. The method as recited in claim 1 wherein said indicating further comprises generating an audible sound when blocked content is selected by a cursor within a listing of scheduled media content that has a blocked status.

9. The method as recited in claim 1 wherein said determining is performed by a processor residing in a set-top box.

10. The method as recited in claim 1 wherein said determining is performed by a processor residing in a display device displaying said grid.

11. A method of displaying electronic program guide information on a display screen, said method comprising:
accessing status information regarding media content scheduled for broadcast;
based on said status information, determining media content that is blocked from display on said display screen; and
displaying electronic program guide information comprising a listing of scheduled media content and wherein said displaying comprises:
displaying listings corresponding to said media content that is blocked using a blocked visual format; and
displaying listings corresponding to media content that is not blocked using a non-blocked visual format.

12. A method as described in claim 11 wherein said status information comprises ratings information for said media content scheduled for broadcast and wherein said determining comprises determining said media content that is blocked based on any media content having a rating information that exceeds a prescribed maximum rating.

13. A method as described in claim 11 wherein said status information comprises subscription information and wherein said determining comprises determining said media content that is blocked based on any media content that is unsubscribed.

14. A method as described in claim 11 wherein said electronic program guide comprises a grid of bar listings and wherein said blocked visual format comprises a font that is different from a font of said non-blocked visual format.

15. A method as described in claim 11 wherein said electronic program guide comprises a grid of bar listings and wherein said blocked visual format comprises background bar color that is different from a background bar color of said non-blocked visual format.

16. A method as described in claim 11 wherein said electronic program guide comprises a grid of bar listings and wherein said blocked visual format is of less intensity compared to said non-blocked visual format.

17. An electronic device comprising a processor coupled to a bus and a memory coupled to said bus wherein said memory is programmed to implement a method of displaying electronic program guide information on a display screen, said method comprising:
accessing status information regarding media content scheduled for broadcast;
based on said status information, determining media content that is blocked from display on said display screen; and
displaying electronic program guide information comprising a listing of scheduled media content and wherein said displaying comprises:
displaying listings corresponding to said media content that is blocked using a blocked visual format; and
displaying listings corresponding to media content that is not blocked using a non-blocked visual format.

18. An electronic device as described in claim 17 wherein said status information comprises ratings information for said media content scheduled for broadcast and wherein said determining comprises determining said media content that is blocked based on any media content having a rating information that exceeds a prescribed maximum rating.

19. An electronic device as described in claim 17 wherein said status information comprises subscription information and wherein said determining comprises determining said media content that is blocked based on any media content that is unsubscribed.

20. An electronic device as described in claim 17 wherein said electronic program guide comprises a grid of bar listings and wherein said blocked visual format comprises a font that is different from a font of said non-blocked visual format.

21. An electronic device as described in claim 17 wherein said electronic program guide comprises a grid of bar listings and wherein said blocked visual format comprises background bar color that is different from a background bar color of said non-blocked visual format.
